(19) United States
(12) Patent Application Publication
(10) Pub. No.: US 2018/0266498 A1
(43) Pub. Date: Sep. 20, 2018

(54) Clutch Device for a Powertrain of a Motor Vehicle, in Particular a Motorcycle, and Method for Operating Such a Powertrain

(71) Applicant: Bayerische Motoren Werke Aktiengesellschaft, Muenchen (DE)

(72) Inventor: Bernd MAIER, Ismaning (DE)

(21) Appl. No.: 15/986,977

(22) Filed: May 23, 2018

Related U.S. Application Data
(63) Continuation of application No. PCT/EP2016/076767, filed on Nov. 7, 2016.

(30) Foreign Application Priority Data
Nov. 24, 2015 (DE) 10 2015 223 140.2

(51) Int. Cl. F16D 25/12; G01D 5/14

(52) U.S. Cl. CPC F16D 25/12; B62K 11/00; G01D 5/142

(57) ABSTRACT

A clutch device for a powertrain of a motor vehicle, in particular a motorcycle, is provided. The clutch device includes a clutch with at least one clutch element that can be moved between at least one engaged position in which a drive assembly of the powertrain is rotationally fixed to at least one additional component of the powertrain, and at least one disengaged position in which the drive assembly is decoupled from the additional component. At least one analog sensor detects at least one measurement variable associated with the movement of the clutch element. The motor vehicle power train may be operated based on the detected at least one measurement variable.

### CROSS REFERENCE TO RELATED APPLICATIONS

This application is a continuation of PCT International Application No. PCT/EP2016/076767, filed Nov. 7, 2016, which claims priority under 35 U.S.C. § 119 from German Patent Application No. 10 2015 223 140.2, filed Nov. 24, 2015, the entire disclosures of which are herein expressly incorporated by reference.

### BACKGROUND AND SUMMARY OF THE INVENTION

The invention relates to a clutch device for a power train of a motor vehicle, in particular a motorcycle, and to a method for operating such a power train.

Such clutch devices for power trains of motor vehicles, in particular motorcycles, and methods for operating such power trains, are known from the general prior art and are already sufficiently known, in particular, from the series production of vehicles. Such a power train comprises at least one drive assembly for driving the motor vehicle. The drive assembly is, for example, an engine by which the motor vehicle can be driven. In particular, the drive assembly can be an internal combustion engine which is embodied, for example, as a reciprocating piston engine. The drive assembly comprises, for example, an output shaft via which the drive assembly makes available torque for driving the motor vehicle.

The clutch device and therefore the power train also comprise a clutch which comprises at least one clutch element. The clutch element is, for example, a friction disk or a friction plate and has here, for example, at least one friction lining. In addition, the clutch element can be a pressure body by which a force, in particular pressure force, can be applied to press together plates of the clutch. In this context, the clutch element can be moved between at least one engaged position and at least one disengaged position, in particular can be moved in a translatory fashion. In the engaged position, the drive assembly is coupled in a rotationally fixed fashion to at least one further component via the clutch element, with the result that, for example, the torque which is made available via the drive assembly for driving the motor vehicle can be transmitted from the drive assembly, in particular from the power shaft, to the further component via the clutch or via the clutch element. For example the torque can then be transmitted from the further component to at least one ground contact element, in particular in the form of a wheel of the motor vehicle, with the result that the wheel and therefore the motor vehicle as a whole can be driven.

In the disclosure, the drive assembly, in particular the output shaft, is decoupled from the further component, with the result that, for example, no torque can be transmitted from the drive assembly to the further component. The further component is, for example, a further shaft, in particular in the form of a transmission input shaft, which in the engaged position of the clutch element is coupled in a rotationally fixed fashion to the drive assembly, in particular the output shaft. As a result, the further shaft cannot rotate relative to the output shaft. However, in the disclosure the further shaft is decoupled from the output shaft, with the result that the further shaft can rotate relative to the output shaft.

Within the scope of the method for operating the power train, there is therefore provision that the clutch element is moved between the engaged position and the disengaged position. The movement of the clutch element usually takes place via a Bowden cable in a motorcycle which is embodied as a two-wheeled vehicle. For this purpose, for example the driver of the motorcycle activates a clutch lever, as a result of which the clutch element is moved out of the engaged position into the disengaged position via the Bowden cable. In addition, hydraulic activation of the clutch element is known, wherein the clutch element is moved hydraulically, that is to say using a hydraulic fluid. The clutch is embodied here as a hydraulic clutch. In this context, for example a force which is applied by the driver of the motor vehicle is transmitted to the clutch element via the hydraulic fluid in order as a result to move the clutch element, in particular out of the engaged position into the disengaged position.

The movement of the clutch element from the engaged position into the disengaged position is also referred to as opening of the clutch, wherein the movement of the clutch element from the disengaged position into the closed position is also referred to as closing of the clutch. The movement of the clutch element from the disengaged position into the engaged position occurs, for example, with at least one spring element which is tensioned in the disengaged position with respect to the engaged position, and as a result makes available a spring force which acts on the clutch element which acts in the disengaged position. Using this spring force, the clutch element can be moved from the disengaged position into the engaged position, wherein the clutch element is held, for example, in the engaged position by the spring element.

The object of the present invention is to develop a clutch device and a method of the type described at the beginning in such a way that particularly advantageous operation of the power train and therefore of the motor vehicle overall can be implemented.

In order to develop a clutch device of the type specified in such a way that particularly advantageous operation of the power train and therefore of the motor vehicle overall can be implemented, at least one analog sensor is provided by which at least one measurement variable which characterizes the movement of the clutch element can be detected in an analog fashion. The realization on which the invention is based is that the state of the clutch, in particular the position of the clutch element, and the knowledge of the state or the position can play an important role during the operation of the powertrain and therefore of the motor vehicle overall. In particular, it is desirable to determine particularly precisely a current position of the clutch element and therefore a current state of the clutch, with the result that it can be determined whether the clutch is actually opened or still closed or rather actually closed or still opened.

The clutch is then opened if the clutch element is in the disengaged position. In addition, the clutch is then closed if the clutch element is in the engaged position. Through the use of the analog sensor and the analog detection of the measurement variable it is possible to be able to detect the movement and therefore the current position of the clutch element particularly precisely. In particular it is possible to be able to determine the movement or position of the clutch element not only qualitatively but also at least virtually quantitatively. This is particularly advantageous with respect to the use of digital sensors by which the movement or a respective position of the clutch can only be detected qualitatively. This is the case with digital sensors, since they can usually display only precisely two states. A first of the states characterizes, for example, the opened clutch, while a second of the states characterizes the closed clutch. However, there is actually a certain degree of inaccuracy with respect to the position of the clutch element, with the result that these two states of a digital sensor reflect the current state of the clutch or the current position of the clutch element only very imprecisely under certain circumstances.

For example, owing to changes in temperature and/or wear, what is referred to as the bite point of the clutch can vary. The bite point is to be understood, for example, as a position of the clutch element at which the clutch element is actually in the disengaged position and the clutch is therefore actually opened. Digital sensors represent this bite point, for example, only with inadequate precision and cannot represent, in particular, varying bite points. It is therefore possible, for example, for a digital sensor to indicate that the clutch is opened even though it is still closed, and vice versa.

These problems and disadvantages can then be avoided by using an analog sensor and the analog detection of the movement of the clutch element since such an analog sensor not only can precisely detect two discrete states, which are different from one another, but also it is possible to use an analog sensor to detect, for example, a continuous profile which characterizes the movement and therefore respective positions of the clutch element and is, for example, essentially continuous. On the basis of this profile it is possible to determine the current position and therefore the current state of the clutch, with the result that particularly precise statements about whether the clutch is actually opened or closed (that is to say whether the bite point has actually been reached, passed or is still not yet reached) can be made. As a result, with the clutch device according to the invention a particularly precise knowledge of the current position of the clutch element and therefore of the current state of the clutch can be acquired, with the result that the power train can be operated particularly advantageously.

The previously described inaccuracy with respect to the bite point of the clutch comes about, in particular, since usually there is a relatively long activation chain between the clutch element and an operator control element which can be activated by the driver of the motor vehicle, wherein the clutch element can be activated by the driver, that is to say can be moved, by the operator control element. In the case of a motor vehicle which is embodied as a two-wheeled vehicle, that is to say in the case of a motorcycle, the clutch element is coupled, for example via a Bowden cable, to the operator control element which is embodied, for example, as a lever, in particular as a clutch lever. In particular it is conceivable for the clutch element to be coupled hydraulically, that is to say via a hydraulic fluid, to the operator control element, and therefore for it to be able to be activated or moved via the hydraulic fluid by activating, that is to say moving, the operator control element. As a result of the use of the analog sensor and the analog detection of the measurement variable, it is therefore possible, despite this inaccuracy, to acquire precise information about whether the clutch is actually opened or closed.

In one advantageous refinement of the invention, the sensor is embodied as an analog travel sensor by which travel which is executed by the clutch element can be detected as the measurement variable in an analog fashion. In particular it is conceivable that the travel which is executed by the clutch element is detected directly by the travel sensor, as a result of which the current position of the clutch element can be detected particularly precisely. In particular it is possible to detect, during a measurement time, a profile of the measurement variable and therefore the travel executed by the clutch element, with the result that the current position of the clutch element can be detected particularly precisely.

In a further advantageous refinement of the invention, the sensor is embodied as a travel sensor by which travel executed by an activation element in order to move the coupling element can be detected as the measurement variable. In this context, the activation element can be a component of the coupling device which is different from the coupling element and coupled or connected to the coupling element. This embodiment is based on the idea of not detecting the coupling element or the travel thereof directly using the analog sensor but rather of detecting the activation element which is coupled to the coupling element and can therefore be moved along with the coupling element (in particular the travel executed by said coupling element) in order then to infer the travel or the position of the clutch element on the basis of the detected travel which has been executed by the activation element. Since the activation element is coupled to the clutch element and therefore can be moved along with it, in this way it is possible to determine the movement or the respective position of the clutch element particularly precisely.

The activation element is, for example, a cable element or a Bowden cable element, in particular a Bowden cable, by which the clutch element in particular can be activated by the driver by the abovementioned operator control element and as a result can be moved. For this purpose, the driver activates or moves, for example, the operator control element. By using or detecting the travel executed by the Bowden cable element, the movement or position of the clutch element can be determined in a particularly precise and easy way.

It has proven particularly advantageous if the sensor is embodied as a Hall sensor. As a result, the position of the clutch element can be determined particularly precisely and easily.

Finally, it has proven advantageous if the clutch element can be moved by a hydraulic fluid. In this context, the sensor is embodied as an analog pressure sensor by which a pressure of the hydraulic fluid which occurs, in particular, when the clutch element moves, can be detected as the measurement variable in an analog fashion. For example, a force which is applied by the driver of the motor vehicle, in particular via the operator control element, is transmitted via the hydraulic fluid and therefore hydraulically to the clutch element in order, as a result, to move the clutch element hydraulically. In this context, the pressure of the hydraulic fluid depends on the movement of the clutch element which is brought about by the driver, with the result that, by detecting the pressure of the hydraulic fluid it is possible to infer the movement and therefore the position of the clutch element. Since the pressure is then detected in an analog fashion by the analog pressure sensor, the travel or the position of the clutch element can be detected particularly precisely.

The invention also includes a motor vehicle having a clutch device according to the invention. Advantages and advantageous refinements of the clutch device according to the invention are to be considered advantageous and advantageous refinements of the motor vehicle according to the invention, and vice versa.

It has proven particularly advantageous here if the motor vehicle is embodied as a motorcycle, that is to say as a two-wheeled vehicle. In particular in the case of a motorcycle, knowledge about the current position of the clutch element is particularly advantageous. The analog detection of the travel or of the position of the clutch element and therefore of the state of the clutch permits particularly advantageous applicability and adaptability with respect to the bite point of the clutch to be implemented.

In order to develop a method of the type specified in such a way that particularly advantageous operation of the powertrain and therefore of the motor vehicle can be implemented overall, according to the invention at least one analog sensor is provided by which at least one measurement variable which characterizes the movement of the clutch element is detected in an analog fashion. Advantages and advantageous refinements of the clutch device according to the invention are to be considered advantages and advantageous refinements of the method according to the invention, and vice versa.

Finally, it is proven advantageous if the powertrain is operated as a function of the measurement variable, that is to say as a function of the detected movement or position of the clutch element. As a result particularly efficient operation can be implemented.

Knowledge about the current position of the clutch element is particularly advantageous for the operation of the drive assembly which is embodied, for example, as an internal combustion engine or combustion engine. If, for example, a computing device in the form of a control unit is provided for operating, in particular closed-loop controlling, the drive assembly, the detected measurement variable can be transmitted to the computing device and received by the computing device, with the result that the drive assembly can be operated by the computing device as a function of the detected measurement variable. Since on the basis of the measurement variable it is possible to detect particularly precisely whether the clutch is actually opened or closed, advantageous and, in particular, efficient operation of the drive assembly can be brought about.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic illustration of a clutch device according to a first embodiment of the present invention, having at least one analog sensor by which at least one measurement variable which characterizes a movement of a clutch element of a clutch of the clutch device can be detected in an analog fashion.

FIG. 2 shows a schematic illustration of the clutch device according to a second embodiment of the present invention.

### DETAILED DESCRIPTION OF THE DRAWINGS

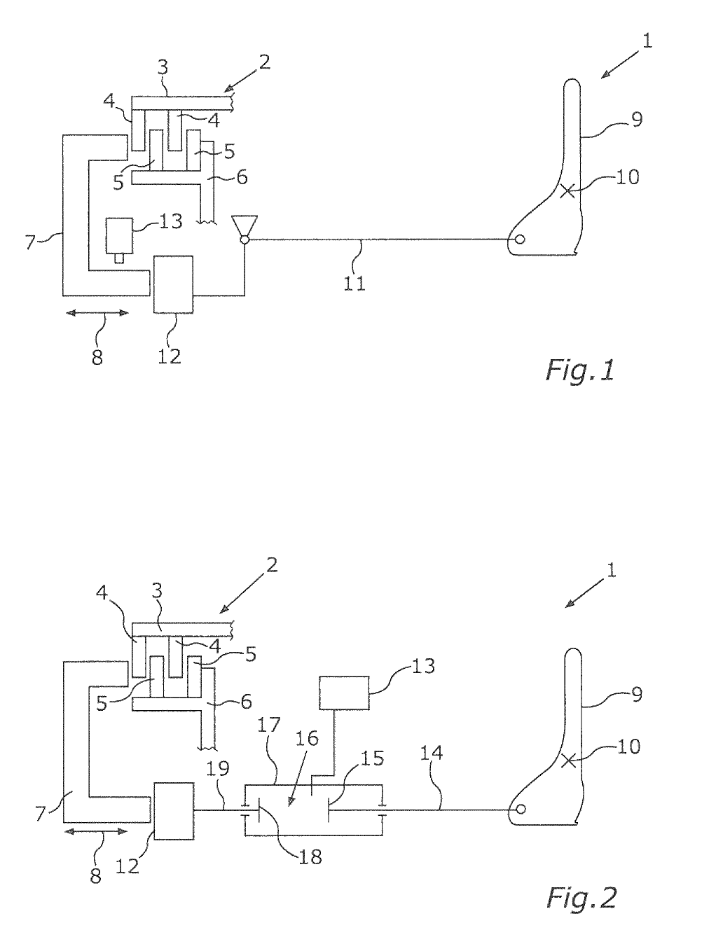

FIG. 1 shows a particularly schematic illustration of a clutch device which is denoted in its entirety by 1, for a power train of a motor vehicle, in particular of a motorcycle which is embodied as a two-wheeled vehicle. The power train is designed to drive the motorcycle and comprises at least one drive assembly which is not illustrated in the figures and by which the motorcycle can be driven. The drive assembly is embodied, for example, as an internal combustion engine, wherein the internal combustion engine has, in its completely produced state, at least one housing element and one output shaft which is mounted on the housing element so as to be rotatable about a rotational axis relative to the housing element. The internal combustion engine is embodied, for example, as a reciprocating piston engine, wherein the output shaft is embodied as a crankshaft. Via the output shaft, the drive assembly makes available torque for driving the motorcycle. In this context, the power train comprises at least one wheel (not illustrated in the figures either) which is, for example, a rear wheel of the motorcycle. The wheel is a ground contact element by which the motorcycle rolls on an underlying surface during travel. In this context, the wheel can be driven by the output shaft and therefore by the drive assembly.

The powertrain also comprises a transmission (not illustrated in the figures either) via which the wheel can be driven by the internal combustion engine. The transmission is designed to convert the torque made available by the internal combustion engine via the output shaft into torque which is different in comparison therewith, that is to say larger or smaller. For this purpose, the transmission comprises at least a first shaft in the form of a transmission input shaft via which the torque which is made available from the internal combustion engine via the output shaft can be input into the transmission. In addition, the transmission comprises at least a second shaft in the form of a transmission output shaft via which the transmission makes available torque for driving the wheel and therefore the motorcycle overall. Therefore, the transmission output shaft can be driven by the output shaft, and therefore by the internal combustion engine, via the transmission input shaft, with the result that the wheel can be driven by the output shaft or the internal combustion engine via the transmission output shaft and the transmission input shaft. The wheel and the transmission, in particular the transmission input shaft and the transmission output shaft, are further components of the powertrain which are provided in addition to the clutch device 1.

The clutch device 1 and therefore the powertrain overall also comprises a clutch 2 which is arranged between the output shaft and the transmission input shaft with respect to a torque flux from the internal combustion engine, in particular the output shaft, to the transmission, in particular the transmission input shaft. The clutch 2 comprises a clutch basket 3, on which first plates in the form of external plates 4 are supported. The external plates 4 of the clutch 2 are supported on the clutch basket 3, in particular, in the circumferential direction thereof, with the result that torque can be transmitted between the clutch basket 3 and the external plates 4. In addition, the clutch 2 comprises second plates in the form of internal plates 5 which are arranged at and, in particular, on a hub 6 of the clutch 2. In particular, the internal plates 5 are supported on the hub 6 in the circumferential direction thereof, with the result that torque can be transmitted between the internal plates 5 and the hub 6.

The clutch 2 also has a pressure body 7 which can move, for example, in a translatory fashion relative to the clutch basket 3 and relative to the hub 6. This translatory mobility of the pressure body 7 is illustrated in FIG. 1 by a double arrow 8. The outer plates 4, the inner plates 5 and the pressure body 7 are clutch elements of the clutch 2. In this context, the pressure body 7 can be moved in a translatory fashion between at least one disengaged position and at least one engaged position, relative to the clutch body 3 and relative to the hub 6. The outer plates 4 and/or the inner plates 5 have friction linings, with the result that—if the outer plates 4 and the inner plates 5 are compressed or pressed together—even high torque can be transmitted between the outer plates 4 and the inner plates 5 and therefore between the clutch basket 3 and the hub 6. In this context, the outer plates 4 and the inner plates 5 can have pressure applied to them by the pressure body 7, with the result that the inner plates 5 and the outer plates 4 are pressed together or compressed as a result of this application of pressure by the pressure body 7.

The clutch 2 also comprises a spring device (not illustrated in FIG. 1) by which the pressure body 7 is held in the engaged position. Therefore in the engaged position of the pressure body 7 the spring device is, for example, tensioned, with the result that the spring device makes available a spring force which acts on the pressure body 7. By this spring force, the pressure body 7 is held in the engaged position. In this engaged position, the outer plates 4 and the inner plates 5 have pressure applied to them by the pressure body 7, and as a result are pressed together or compressed, with the result that the clutch 2 is closed and torques can be transmitted between the clutch basket 3 and the hub 6 via the plates (outer plates 4 and inner plates 5).

In this context, for example the clutch basket 3 can be driven by the output shaft of the internal combustion engine, wherein the transmission input shaft can be driven by the hub 6. For example, the transmission input shaft is connected to the hub 6 in a rotationally fixed fashion, wherein alternatively or additionally there can be provision for the clutch basket 3 to be connected in a rotationally fixed fashion to the output shaft.

The transmission input shaft can therefore be driven by the output shaft via the hub 6, the inner plates 5, the outer plates 4 and the clutch basket 3 if the pressure body 7 is in its engaged position, with the result that the clutch 2 is then closed. In the engaged position, the hub 6 which is arranged in the clutch basket 3 therefore cannot rotate relative to the clutch basket 3, with the result that the transmission input shaft cannot rotate relative to the drive shaft either. If the pressure body 7 is moved out of the engaged position into the disengaged position, the spring device is tensioned, with the result that in the disengaged position the spring device is tensioned more strongly than in the engaged position. As a result, in the disengaged position the spring device makes available a spring force which acts on the pressure body 7 which is in the disengaged position. By this spring force which acts on the pressure body 7 in the disengaged position, the spring body 7 can be moved out of the disengaged position into the engaged position.

In the disengaged position, the plates of the clutch 2 are not pressed together or compressed by the pressure body 7, with the result that the hub 6 is decoupled from the clutch basket 3, and therefore the transmission input shaft is decoupled from the output shaft. In the disengaged position, the inner plates 5 can therefore rotate relative to the outer plates 4, with the result that the hub 6 can rotate relative to the clutch basket 3, and therefore the transmission input shaft can rotate relative to the output shaft. In the disengaged position of the pressure body 7, the clutch 2 is opened. In this context, the transmission input shaft is decoupled from the output shaft.

In order to move the pressure body 7, in accordance with demand, between the engaged position and the disengaged position, in particular out of the engaged position into the disengaged position, the clutch device 1 comprises an operator control element in the form of a lever 9 which is also referred to as a clutch lever. In the completely produced state of the motor vehicle, the lever 9 is held, for example, on a steering handle, in particular handlebars, of the motor vehicle, wherein the lever 9 is held in a movable fashion on the handlebars. The lever 9 can pivot relative to the handlebars about a pivoting axis 10 here. In this context, the lever 9 is coupled to the pressure body 7 via activation elements 11 and 12, with the result that the pressure body 7 can be activated, that is to say can be moved, by activation, that is to say movement, of the lever 9, and in the process can be moved, for example, from the engaged position into the disengaged position. If the driver of the motor vehicle applies, for example, a force to the lever 9 in such a way that the driver pulls on the lever 9, the force which is applied to the lever 9 by the driver is transmitted to the pressure body 7 via the activation elements 7 and 12, as a result of which the pressure body 7 is moved out of the engaged position into the disengaged position. In this process, the activation element 12 is, for example, a pressure element which presses on the pressure body 7 when the lever 9 is activated. The activation element 11 is a Bowden cable element, also referred to as a cable element, and is embodied, for example, as a Bowden cable. The Bowden cable element is in itself flexible and serves to transmit tensile forces, but cannot transmit any compressive forces.

In order then to implement overall particularly advantageous operation of the powertrain, and therefore of the motor vehicle, at least one analog sensor 13 (illustrated particularly schematically in FIG. 1), is provided, by which analog sensor 13 at least one measurement variable which characterizes the movement of the pressure body 7 can be detected in an analog fashion. The analog sensor 13 is embodied here as an analog travel sensor by which travel which is executed by the pressure body 7 can be detected as the measurement variable in an analog fashion, and in particular directly. For example the travel sensor is embodied as a Hall sensor with which the travel which is executed by the pressure body 7 is detected directly. Alternatively or additionally, it is conceivable to use an analog sensor with is embodied, for example, as an analog travel sensor by which travel which is executed by the activation element 11 and/or 12 which is coupled to the pressure body 7 and different from the pressure body 7 can be detected as the measurement variable in an analog fashion. This means that there is provision, for example, for the travel which is executed by activation element 11 and/or 12 to be detected in an analog fashion, in particular directly, by at least one analog sensor.

Using the analog detection of the measurement variable it is possible to determine a current position of the pressure body 7, and therefore a current state of the clutch 2, particularly precisely, with the result that, for example, it is possible to determine particularly precisely whether the clutch 2 is actually opened or closed. As a result, it becomes possible to operate the power train as a function of the detected measurement variable and therefore as a function of the actual current state of the clutch 2, with the result that particularly advantageous and, in particular, efficient and therefore more energy-economical operation of the power train can be implemented. In this context, FIG. 1 shows a first embodiment of the clutch device 1.

FIG. 2 shows a second embodiment of the clutch device 1. The second embodiment differs in particular with respect to the transmission of the force applied by the driver from the lever 9 to the pressure body 7 in order to move the pressure body 7. In the first embodiment, the mechanical activation elements 11 and 12 and/or further transmission elements or activation elements (not shown in FIG. 1) are provided for transmitting the force applied by the driver from the lever 9 to the pressure body 7. In contrast to this, in the second embodiment hydraulic activation of the pressure body 7 is provided. In this context, the lever 9 is coupled, for example, in an articulated fashion to a piston rod 14 which is connected to a piston 15. The piston rod 14 can therefore be moved, in particular in a translatory fashion, by activating or moving the lever 9, wherein the piston 15 moves along with the piston rod 14. The piston 15 is accommodated in a translatory mobile fashion in a working space 16 of a cylinder 17, wherein a hydraulic fluid (not illustrated in FIG. 2) is accommodated in the working space 16.

A second piston 18 is accommodated in a translatory mobile fashion in the working space 16, wherein the second piston 18 is connected to a second piston rod 19. As a result, the piston rod 19 can be moved along with the piston 18. The piston rod 19 is connected to the activation element 12, with the result that the activation element 12 can be driven or moved by the piston 18 via the piston rod 19. As in the first embodiment, the activation element 12 can be moved in a translatory fashion here, with the result that the pressure body 7 can be moved by the activation element 12.

The pistons 15 and 18 are coupled to one another fluidically via the hydraulic fluid accommodated in the working space 16, with the result that the piston 18 can be driven or moved by the piston 15 via the hydraulic fluid. The force which is applied to the lever 9 by the driver to move the pressure body 7 is therefore transmitted to the piston 18 via the hydraulic fluid, with the result that hydraulic activation of the pressure body 7 is provided.

In the second embodiment, the analog sensor 13 is embodied as an analog pressure sensor by which a pressure of the hydraulic fluid can be detected as the measurement variable in an analog fashion. The pressure of the hydraulic fluid in the working space 16 is dependent, in particular, on the activation of the lever 9 and therefore on the movement of the pressure body 7, with the result that particularly precise inferences can be made about the movement or position of the pressure body 7 by analog detection of the pressure.

The measurement variable which is detected by the analog sensor 13 is fed, for example, to a computing device in the form of a control unit of the power train, wherein the control unit receives the measurement variable. As a result it is possible to operate the power train, in particular the motor vehicle overall, as a function of the measurement variable by the control unit. Since the state or status of the clutch 2 can be detected particularly precisely and, in particular, unambiguously, by the analog sensor 13, particularly advantageous operation of the powertrain and therefore of the motor vehicle overall can be implemented.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMBERS

1 Clutch device
2 Clutch
3 Clutch basket
4 Outer plate
5 Inner plate
6 Hub
7 Pressure body
8 Double arrow
9 Lever
10 Pivoting axis
11 Activation element
12 Activation element
13 Analog sensor
14 Piston rod
15 Piston
16 Working space
17 Cylinder
18 Piston
19 Piston rod

What is claimed is:

1. A clutch device for a power train of a motor vehicle, comprising:
at least one clutch element movable between
at least one engaged position in which a drive assembly of the power train is coupled in a rotationally fixed fashion to at least one further component of the power train, and
at least one disengaged position in the drive assembly is decoupled from the at least one further component of the power train; and
at least one analog sensor configured to detect at least one measurement variable associated with movement of the at least one clutch element.

2. The clutch device as claimed in claim 1, wherein
the at least one analog sensor is an analog travel sensor, and
the at least one measurement variable is an amount of movement of the at least one clutch element.

3. The clutch device as claimed in claim 1, wherein
the at least one analog sensor is a travel sensor configured to detect movement of an activation element separate from and coupled to the at least one clutch element, and
the at least one measurement variable is an amount of movement of the activation element in response to movement of the at least one clutch element.

4. The clutch device as claimed in claim 3, wherein
the activation element is a Bowden cable.

5. The clutch device as claimed in claim 1, wherein
the at least one analog sensor is a Hall sensor.

6. The clutch device as claimed in claim 3, wherein
the at least one clutch element is movable by a hydraulic fluid, and
the at least one analog sensor is an analog pressure sensor configured to detect a pressure of the hydraulic fluid.

7. A motor vehicle, comprising:
a power train; and
a clutch device, the clutch device including
at least one clutch element movable between
at least one engaged position in which a drive assembly of the power train is coupled in a rotationally fixed fashion to at least one further component of the power train, and
at least one disengaged position in the drive assembly is decoupled from the at least one further component of the power train; and
at least one analog sensor configured to detect at least one measurement variable associated with movement of the at least one clutch element.

8. The motor vehicle as claimed in claim 7, wherein
the motor vehicle is a motorcycle.

9. A method for operating a power train of a motor vehicle, comprising the acts of:
moving at least one clutch element between at least one engaged position in which the at least one clutch element couples in a rotationally fixed fashion a drive assembly of the power train to at least one further component of the power train, and at least one disengaged position in which the drive assembly is decoupled from the further component; and
detecting at least one measurement variable associated with movement of the at least one clutch element using at least one analog sensor.

10. The method as claimed in claim 9, wherein
the at least one analog sensor is an analog travel sensor, and
the at least one measurement variable is an amount of movement of the at least one clutch element.

11. The method as claimed in claim 10, wherein
the at least one analog sensor is a travel sensor configured to detect movement of an activation element separate from and coupled to the at least one clutch element, and
the at least one measurement variable is an amount of movement of the activation element in response to movement of the at least one clutch element.

12. The method as claimed in claim 9, further comprising:
operating the power train is operated based on the detected at least one measurement variable.
